(19) United States
(12) Patent Application Publication
(10) Pub. No.: US 2023/0347411 A1
(43) Pub. Date: Nov. 2, 2023

(54) NICKEL NANOWIRE AND METHOD FOR PRODUCING THE SAME

(71) Applicant: UNITIKA LTD., Osaka-shi, Osaka (JP)

(72) Inventors: Hirotaka TAKEDA, Uji-shi, Kyoto (JP); Chikako YAMADA, Uji-shi, Kyoto (JP)

(73) Assignee: UNITIKA LTD., Osaka-shi, Osaka (JP)

(21) Appl. No.: 18/020,509

(22) PCT Filed: Jul. 20, 2021
(86) PCT No.: PCT/JP2021/027115

§ 371 Date: Feb. 9, 2023

(30) Foreign Application Priority Data
Aug. 13, 2020 (JP) 2020-136833

(51) Int. Cl. B22F 1/054; B22F 9/24

(52) U.S. Cl. CPC B22F 9/24; B22F 1/0547; B22F 2301/15; B22F 2304/054; B22F 2304/10

(57) ABSTRACT

The present invention provides nickel a nanowire, which is able to form a structure such as non-woven fabric adequately excellent in high-temperature resistance properties and is adequately excellent in magnetic properties. The present invention relates to a nickel nanowire having a face-centered cubic lattice structure, a crystallite size in a direction of a (111) lattice plane of 15 nm or more and a saturation magnetization of 20 emu/g or more.

### TECHNICAL FIELD

The present invention relates to a nickel nanowire and a method for producing the same.

### BACKGROUND ART

Since nickel nanowires are ferromagnetic materials, the nickel nanowires can be used not only as an electrically conductive material such as a transparent electrically conductive film or a high dielectric constant material but also as a magnetic material such as an electrical wave absorbing material. The nanowires are characterized by exhibiting percolation and magnetic anisotropy due to the anisotropy (high aspect ratio) of the fibrous shape, and it is possible to obtain performance that cannot be obtained with particles (Patent Literature 1).

For example, the nickel nanowires disclosed in Patent Literature 1 are produced by reduction of a single kind of nickel salt, and have a crystallite size in a direction of a (111) lattice plane of more than 10 nm and less than 15 nm.

### PRIOR ART LITERATURE

### Patent Literature

Patent Literature 1: WO 2019/073833 A1

### SUMMARY OF INVENTION

### Problems to Be Solved by the Invention

The inventors of the present invention have found that conventional nickel nanowires have a problem of poor high-temperature resistance properties.

Specifically, the nickel nanowires may be used or treated in a high-temperature environment depending on an intended use of a battery electrode member, a capacitor, or the like. For example, a structure such as a non-woven fabric comprising the nickel nanowires shrank and/or fused under a high-temperature environment, causing a volume change based on a shape change. For this reason, the structure has a problem that delamination and/or cracking easily occur. Delamination is a phenomenon in which a structure of the nickel nanowires and attached to another member delaminates during use. Cracking is a phenomenon in which cracks are formed in a structure of the nickel nanowires.

Even if the nickel nanowires have high-temperature resistance properties, there arose a problem that magnetic properties such as magnetic anisotropy expected for the nanowires are deteriorated.

The present invention solves the problems described above and an object thereof is to provide nickel nanowires which are able to form a structure such as non-woven fabric adequately excellent in high-temperature resistance properties and are adequately excellent in magnetic properties.

### Means for Solving Problems

The present inventors found that the object described above is achieved by controlling the crystallite size within a specific range, and have reached the present invention.

That is, the gist of the present invention is as follows.

<1> A nickel nanowire having a face-centered cubic lattice structure, a crystallite size in a direction of a (111) lattice plane of 15 nm or more and a saturation magnetization of 20 emu/g or more.

<2> The nickel nanowire of <1>, having an average diameter of 50 nm or more and less than 1 µm.

<3> The nickel nanowire of <1> or <2>, wherein a content ratio (hcp/fcc) of a hexagonal closest packing structure to the face-centered cubic lattice structure in the nickel nanowire is 0.2 or less.

<4> The nickel nanowire of any one of <1> to <3>, wherein the nickel nanowire is composed of nickel having only the face-centered cubic lattice structure.

<5> The nickel nanowire of any one of <1> to <4>, wherein the nickel nanowire has an average length of 10 µm or more.

<6> The nickel nanowire of any one of <1> to <5>, wherein a crystallite size in a direction of a (110) lattice plane is 10 nm or more, and

a crystallite size in a direction of a (100) lattice plane is 10 nm or more.

<7> The nickel nanowire of any one of <1> to <6>, wherein the crystallite size in the direction of the (111) lattice plane is 30 nm or more.

<8> A dispersion comprising the nickel nanowire of any one of <1> to <7>.

<9> A molded article comprising the nickel nanowire of any one of <1> to <7>.

<10> A method for producing a nickel nanowire, the method comprising reducing two or more kinds of nickel salts including nickel sulfate in a reaction solution while applying a magnetic field to obtain the nickel nanowire of any one of <1> to <7>.

<11> The method for producing the nickel nanowire of <10>, wherein the two or more kinds of nickel salts include nickel sulfate and nickel chloride, and

a ratio of the nickel sulfate to a total of the nickel sulfate and the nickel chloride is 70 to 98 mol%.

### Effects of the Invention

Nickel nanowires of the present invention are able to form a structure such as non-woven fabric adequately excellent in high-temperature resistance properties and are adequately excellent in magnetic properties such as magnetic anisotropy.

### BRIEF DESCRIPTION OF DRAWINGS

FIG. 1 is a diffraction pattern of WAXD (wide angle X-ray diffraction measurement) of the nickel nanowires produced in Example 1.

FIG. 2 is a diffraction pattern of WAXD of the nickel nanowires produced in Comparative Example 1.

FIG. 3 is a diffraction pattern of WAXD of the nickel nanowires produced in Comparative Example 2.

FIG. 4 is a diffraction pattern of WAXD of the nickel nanowires produced in Comparative Example 3.

### MODES FOR CARRYING OUT THE INVENTION

### Nickel Nanowires

The nickel nanowires of the present invention are required to have an fcc structure (that is, face-centered cubic lattice structure) as the crystal structure thereof. The lattice structure (or crystal structure) can be analyzed by WAXD.

That the nickel nanowires have the fcc structure means that the nickel nanowires exhibit one or more (particularly, three) main peaks unique to a so-called fcc type crystal structure at prescribed incident angles in X-ray diffraction under the following conditions. Examples of the main peak unique to the fcc structure include a peak (111) at 20 = 44.4°, a peak (200) at 2θ = 51.6 to 51.9°, and a peak (220) at 2θ = 76.3°.

Conditions: CuKα ray = 1.54 Å, 50 kV, 300 mA, 2θ/θ method.

The nickel nanowires of the present invention are preferably composed of nickel having only an fcc structure from the viewpoint of further improvement in high-temperature resistance properties and magnetic properties. The nickel nanowires of the present invention are not always strictly required to have only the fcc structure as a crystal structure, and may contain other crystal structures (for example, an hcp structure (i.e., a hexagonal closest packing structure)). For example, the nickel nanowires of the present invention mainly have an fcc structure and may contain an hcp structure.

The content ratio (hcp/fcc) of the hcp structure of the nickel nanowires of the present invention is usually 0.15 or less, and from the viewpoint of magnetic properties, the content ratio is preferably 0.1 or less (particularly, less than 0.1), and more preferably 0. The content ratio (hcp/fcc) of the hcp structure is a ratio of the hcp structure to the fcc structure in the nickel nanowires. Specifically, as the content ratio of the hcp structure, there is used a value calculated as a ratio (hcp(010)/fcc(200)) of an integral value of a peak (010) at 2θ = 37.2° in the hcp structure to an integral value of a peak (200) at 2θ = 51.6 to 51.9° in the fcc structure in a diffraction pattern of WAXD (wide-angle X-ray diffraction measurement, CuKα ray = 1.54 Å, 50 kV, 300 mA, 2θ/θ method).

The reason why a structure such as a non-woven fabric formed of a plurality of nickel nanowires causes delamination or cracks in a high-temperature environment is considered to be that the nickel nanowires have a relatively small crystallite size. Specifically, since nickel nanowires having a relatively small crystallite size have a relatively large number of interfaces between crystallites per nanowire, shrinkage and/or fusion due to over-annealing is likely to occur, and as a result, volume change is likely to occur in the structure. Therefore, it is considered that delamination and cracks are likely to occur in a high-temperature environment.

The crystallite size of the nickel nanowires of the present invention is required to be 15 nm or more, and is preferably 30 nm or more and more preferably 40 nm or more from the viewpoint of further improvement in high-temperature resistance properties and magnetic properties. As a result, since the nickel nanowires of the present invention have a relatively small number of interfaces between crystallites per nanowire, shrinkage and fusion are adequately inhibited in a high-temperature environment, so that the nickel nanowires are adequately excellent in high-temperature resistance properties. As a result, it is considered that a structure such as a non-woven fabric comprising the nickel nanowires of the present invention can adequately inhibit volume change in a high-temperature environment, so that it can adequately inhibit the occurrence of delamination and/or cracks in a high-temperature environment. Moreover, since the nickel nanowires of the present invention an adequately reduced content of the hcp structure, the nickel nanowires are adequately excellent in magnetic properties such as magnetic anisotropy. When the crystallite size is excessively small, nickel nanowires have a relatively large number of interfaces between crystallites per nanowire, so that shrinkage and fusion are likely to occur in a high temperature environment, deteriorating high-temperature resistance properties. As a result, a structure such as a non-woven fabric comprising the nickel nanowires is likely to cause volume change in a high-temperature environment, so that delamination and/or cracks occur in a high-temperature environment.

The upper limit value of the crystallite size is not particularly limited, but when the crystallite size is excessively large, nanowires cannot be produced in some cases. For this reason, the crystallite size of the nickel nanowires of the present invention is usually 100 nm or less (particularly 80 nm or less), and from the viewpoint of further improving magnetic properties, the crystallite size is preferably 60 nm or less, and more preferably 50 nm or less.

The crystallite size in the nickel nanowires of the present invention is defined to be a size in a direction of a (111) lattice plane of fcc. The direction of a (111) lattice plane is a direction perpendicular to the (111) lattice plane.

The crystallite size in a direction of a (110) lattice plane in the nickel nanowires of the present invention is usually 10.0 nm or more (particularly 10.0 to 80.0 nm), and from the viewpoint of further improvement in high-temperature resistance properties and magnetic properties, the crystallite size is preferably 10.0 to 60.0 nm, more preferably 20.0 nm or more and 60.0 nm or less, and still more preferably 30.0 nm or more and 50.0 nm or less.

The crystallite size in a direction of a (100) lattice plane in the nickel nanowires of the present invention is usually 10.0 nm or more (particularly 10.0 to 80.0 nm), and from the viewpoint of further improvement in high-temperature resistance properties and magnetic properties, the crystallite size is preferably 10.0 to 60.0 nm, more preferably 20.0 nm or more and 60.0 nm or less, and still more preferably 30.0 nm or more and 50.0 nm or less.

In the present description, the crystallite size in the direction of each lattice plane is a value calculated from a peak of WAXD. In the case of fcc nickel, since the reflections of the (100) lattice plane and the (110) lattice plane cannot be directly observed due to the extinction rule, values calculated from the peaks of a (200) lattice plane and a (220) lattice plane are used, respectively.

Usually, a nanowire is a fibrous substance having an average diameter on nanoscale. In addition, the average diameter of the nickel nanowires of the present invention is always larger than the crystallite size in the direction of each lattice plane. In the present invention, the average diameter of nickel nanowires is preferably 50 nm or more and less than 1 µm, more preferably 50 to 500 nm, still more preferably 90 to 300 nm, and particularly preferably 100 to 250 nm from the viewpoint of handling and the viewpoint of further improvement in high-temperature resistance properties and magnetic properties.

In the present description, as the average diameter of nickel nanowires, an average value of nickel nanowire diameters at arbitrary 100 points in 10 visual fields observed by a transmission electron microscope (600,000 magnifications) is used.

The average length of nickel nanowires is preferably 10 µm or more, more preferably 10 to 40 µm, still more preferably 10 to 30 µm, and further preferably 15 to 30 µm from the viewpoint of handleability, electrical conductivity, and the like as well as from the viewpoint of further improvement in high-temperature resistance properties and magnetic properties.

In the present description, as the average length of nickel nanowires, an average value of the lengths of arbitrary 200 nickel nanowires measured by a scanning electron microscope (2000 to 6000 magnifications) is used.

The aspect ratio (average length/average diameter) of the nickel nanowires of the present invention is usually 50 or more, and from the viewpoint of further improvement in magnetic properties, the aspect ratio is preferably 60 or more, more preferably 70 or more, still more preferably 80 or more, and particularly preferably 90 or more. The upper limit value of the aspect ratio is not particularly limited, and the aspect ratio is usually 300 or less, and particularly 250 or less.

The nickel nanowires of the present invention are ferromagnetic materials and have a saturation magnetization of 20 emu/g or more. From the viewpoint of further improvement in magnetic properties, the saturation magnetization of the nickel nanowires of the present invention is preferably 30 emu/g or more, more preferably 40 emu/g or more, and still more preferably 45 emu/g or more. The upper limit value of the saturation magnetization is not particularly limited, and the saturation magnetization of the nickel is usually 60 emu/g or less, and particularly 55 emu/g or less.

In the present description, the saturation magnetization can be measured by a vibrating sample magnetometer (VSM) as described later. In particular, nickel nanowires with a content ratio of the hcp structure of more than 0.1 (especially, more than 0.15) do not have adequate magnetic properties and have a saturation magnetization of less than 20 emu/g.

### Method for Producing Nickel Nanowires

The nickel nanowires of the present invention can be obtained by reduction using two or more (particularly two) kinds of nickel salts including nickel sulfate in a reaction solution while applying a magnetic field. Conventionally, a control technique for increasing the crystallite size of a nickel nanowire has not been known. In the present invention, using two or more kinds of nickel salts including nickel sulfate makes it possible to obtain a nickel nanowire having a relatively large crystallite size and adequately excellent magnetic properties as compared with the case of using a single nickel salt. When only nickel sulfate is used, an increased crystallite size is attained, but a hcp (hexagonal closest packing) structure, which is not ferromagnetic, is mixed in the growth process of the nanowire, so that magnetic properties are deteriorated. Furthermore, the growth into a nanowire may be insufficient, or a nanowire may not be formed. Even if two kinds of nickel salts are used, when the two kinds of nickel salts do not include nickel sulfate, the crystallite size of nickel nanowires is reduced and/or the magnetic properties are deteriorated.

Examples of a salt to be combined with nickel sulfate include nickel chloride, nickel nitrate, nickel acetate, and nickel carbonate. The salt may be either a hydrate or an anhydride. Among them, from the viewpoint of further improvement in high-temperature resistance properties and magnetic properties, nickel chloride and/or nickel acetate are more preferable, and nickel chloride is still more preferable as the salt to be combined with nickel sulfate.

When the total concentration of the nickel salts in the reaction solution is excessively high, nanowires cannot be formed, and when the total concentration is excessively low, the production efficiency tends to be deteriorated. The total concentration of the nickel salts in the reaction solution is preferably 0.01 to 1 mmol/g, more preferably 0.015 to 0.25 mmol/g, and still more preferably 0.015 to 0.030 mmol/g from the viewpoint of further improvement in high-temperature resistance properties and magnetic properties.

As to a preferred concentration ratio of each nickel salt in the reaction solution, the ratio of nickel sulfate to the total of nickel sulfate and the other nickel salts is preferably 75 to 98 mol%, more preferably 85 to 98 mol%, and still more preferably 85 to 95 mol%. When the ratio is 50 mol% or more and less than 70 mol%, nanowires may not be formed and may be obtained in the form of particles. When the ratio is less than 50 mol%, the crystallite size in a direction of a (111) lattice plane in the nanowires is reduced.

The solvent to be used for the reaction solution is not particularly limited, and highly polar solvents such as water, alcohols, and NMP, and glycol-based solvents having a high boiling point and a high polarity such as ethylene glycol and propylene glycol are preferable because these easily dissolve the nickel salts.

The reducing agent for reducing the nickel salts is not particularly limited, and hydrazine monohydrate (hydrazine) is preferable from the viewpoint of further improvement in high-temperature resistance properties and magnetic properties. Phosphorus-based and borane-based reducing agents such as hypophosphorous acid and dimethylamine borane, which are common reducing agents for electroless nickel plating, cause phosphorus and boron to become impurities in the metal, and reduce the crystallinity itself of the metal. For this reason, nanowires may not be formed or the magnetic properties of resulting nickel nanowires may be deteriorated. Therefore, these types of reducing agents are unfavorable. In addition, organic reducing agents such as glycol and ascorbic acid are not preferable because they require a high temperature of 200° C. or more, and therefore the magnetic field and the state (temperature, boiling, etc.) of the solvent used in the reaction are not stable.

When hydrazine monohydrate is used as a reducing agent, the molar amount of the hydrazine monohydrate is preferably 1.1 to 2.0 times, and more preferably 1.2 to 1.8 times with respect to the total amount of the nickel salts. When the molar amount of the hydrazine monohydrate is less than 1.1 times with respect to the total amount of the nickel salts, unreacted nickel salts remain, resulting in poor efficiency. On the other hand, when the molar amount is more than 2.0 times, the reaction is excessively active, so that the reaction solution may generate bubbles and the formation of nanowires may be inhibited.

When the nickel salts are reduced with hydrazine monohydrate, the reaction temperature and the liquid properties of the reduction reaction are important. When the reaction temperature is excessively high, the reaction system is made unstable due to bubbling by a generated gas, and when the reaction temperature is excessively low, the reduction reaction per se tends not to occur. The reaction temperature is preferably set to equal to or lower than the boiling point of hydrazine at normal pressure (114° C.), and from the viewpoint of adjustment of the reaction temperature and the amount of a generated gas and convective diffusion, the reaction temperature is preferably set to 80 to 100° C., and particularly 80 to 95° C. When the reaction temperature is 80 to 100° C., particularly 80 to 95° C., the liquid property is preferably made alkaline. In order to make the liquid property alkaline, it is preferable to use a hydroxide salt such as sodium hydroxide. However, depending on the concentration of the hydroxide salt, precipitation of insoluble nickel hydroxide may occur. In this case, precipitation can be inhibited by using sodium hydroxide in combination with ammonia. When sodium hydroxide is used, the concentration of sodium hydroxide in the reaction solution is preferably set to 0.020 to 1 mmol/g (particularly 0.025 to 1 mmol/g), and more preferably 0.020 to 0.5 mmol/g (particularly 0.025 to 0.5 mmol/g). Ammonia redissolves nickel hydroxide precipitates by forming ammine complexes. The added amount of ammonia is not particularly limited, but an excessive amount of ammonia with respect to nickel hydroxide is required for redissolution, whereas the excessive amount of ammonia makes the reaction system unstable due to endotherm by heat of vaporization. For this reason, the added amount of ammonia is usually preferably in the range of 3 to 30 mol with respect to 1 mol of sodium hydroxide, and from the viewpoint of further improvement in high-temperature resistance properties and magnetic properties, the added amount is more preferably in the range of 10 to 30 mol, and still more preferably in the range of 10 to 20 mol. Ammonia is preferably added in the form of ammonia water from the viewpoint of acquisition control, etc. The added amount of ammonia per mol of sodium hydroxide is just required to be within the above range in the reaction solution.

A complexing agent such as a citrate salt may be added to the reaction solution. However, the crystallite size of the nickel nanowires tends to be decreased by adding the complexing agent. Therefore, from the viewpoint of further improvement in high-temperature resistance properties based on the increase in crystallite size, the concentration of the complexing agent is preferably set to 15 mol% or less, more preferably 10 mol% or less, and still more preferably 8 mol% or less with respect to the total number of moles of the nickel salts. When the concentration of the complexing agent is excessively high, the reduction reaction may be less likely to occur, decreasing in production efficiency.

The reaction is carried out in a magnetic field. The central magnetic field is preferably 10 to 200 mT, and more preferably 80 to 180 mT. If no magnetic field is applied during the reaction, nickel nanowires cannot be produced.

The reduction time of the reduction reaction is not particularly limited as long as nickel nanowires are produced, but is usually 1 hour or less, and preferably about 10 to 40 minutes.

After the reduction reaction, the nickel nanowire can be obtained by purifying and collecting them by centrifugation, filtration, attraction with a magnet, or the like. After the reaction, ammonia may be added prior to the collection of the nickel nanowires. As a result, precipitates of nickel hydroxide produced as a by-product can be dissolved, and impurities can be easily removed.

### Dispersion, Coating Material, Paste, and Molded Article

A dispersion can be formed by dispersing the nickel nanowires of the present invention in a medium such as water, an organic solvent or a mixed solvent thereof, and/or a curable resin. As the organic solvent, any organic solvent conventionally used as a medium of a nanowire dispersion can be used, and examples thereof include acetone, isobutyl alcohol, isopropyl alcohol, isopentyl alcohol, ethanol, ethyl ether, ethylene glycol, ethylene glycol monoethyl ether, ethylene glycol monoethyl ether acetate, ethylene glycol mono-n-butyl ether, ethylene glycol monomethyl ether, dichlorobenzene, xylene, cresol, chlorobenzene, isobutyl acetate, isopropyl acetate, isopentyl acetate, ethyl acetate, ethylene glycol n-butyl ether acetate, n-propyl acetate, n-pentyl acetate, methyl acetate, cyclohexanol, cyclohexanone, N,N-dimethylformamide, tetrahydrofuran, 1,1,1-trichloroethane, toluene, n-hexane, propylene glycol, 1-butanol, 2-butanol, methanol, methyl ethyl ketone, methyl cyclohexanol, methyl cyclohexanone, and methyl-n-butyl ketone. Examples of the curable resin include an acrylic resin, an epoxy resin, a silicone resin, and a phenol resin.

The content of the nickel nanowires in the dispersion is not particularly limited, and may be, for example, 0.01 to 50 parts by mass, and particularly 0.1 to 10 parts by mass, with respect to 100 parts by mass of the medium.

A dispersion comprising the nickel nanowires of the present invention may be mixed with a binder resin or with a curing agent that cures a curable resin and then used as a coating material, an adhesive, or a molding material. In addition, a leveling agent, a wetting agent, an antifoaming agent, an inorganic filler for the purpose of heat conduction, and the like may be added to the dispersion.

Examples of the binder resin and the curable resin include an acrylic resin, a urethane resin, an epoxy resin, a silicone resin, and a phenol resin. Examples of the curing agent include an aldehyde, an amine, an isocyanate, an imidazole, a carboxylic acid, an acid anhydride, a hydrazide, and a formaldehyde-based compound.

A dispersion, a coating material, and a paste each comprising the nickel nanowires of the present invention can be used for coating and the like as conventionally performed. The resulting coating film is an electrical conductor or a high dielectric constant material, and is suitable for an electric wiring, an electrode material, an electrical wave shielding material, an antenna substrate, an electrical wave absorbing material, and the like.

In particular, a nanowire film in the form of a non-woven fabric obtained by coating and drying a dispersion comprising the nickel nanowires of the present invention is useful as a battery electrode.

A molded article can also be formed by mixing, melting, kneading, and molding the nickel nanowires of the present invention with other substances (e.g., a polymer). Examples of other substances include polymers (particularly, thermoplastic polymers) similar to the binder resin mentioned above. The method for mixing, melting, and kneading with other substances is not particularly limited, and examples thereof include a method involving mixing, melting, and kneading with a mixer, a screw type extruder, or the like. The molding method is also not particularly limited, and examples thereof include press molding and injection molding.

In particular, a sheet-shaped molded article obtained by mixing, melting, kneading, molding, and heat-treating the nickel nanowires of the present invention with a binder resin is useful as an electric wiring, an electrode material, an electrical wave shielding material, an antenna substrate, an electrical wave absorbing material, and the like.

A structure comprising the nickel nanowires of the present invention includes the nickel nanowire film (for example, non-woven fabric) and the molded article (for example, sheet-shaped molded article) described above. The structure comprising the nickel nanowires of the present invention (particularly, a nickel nanowire film (non-woven fabric)) exhibits a little change in shape in a high-temperature environment, and is less likely to cause delamination and cracks. Therefore, the structure can be treated at a high temperature. The nickel nanowires of the present invention can be suitably mixed with polyimide, ceramic, or the like and thermally cured. In the resulting structure (particularly, a molded article), the nickel nanowires are inhibited from peeling at the interfaces between the nanowires and other substances (particularly, a binder resin or ceramic), so that the strength deterioration of the structure is inhibited. In addition, since fusion between the nanowires due to a high-temperature environment (for example, thermal curing) is inhibited, destruction of the nanowires per se due to a subsequent volume change is adequately inhibited.

### EXAMPLES

Hereinafter, the present invention is described by way of Examples, but the present invention is not limited by these inventions. Physical properties of nickel nanowires were measured by the following methods.

### Average Diameter

Obtained nanowires were dispersed in ethanol, thinly applied onto a grid with a supporting film, and dried. The obtained sample was photographed at a magnification of 600,000 using a transmission electron microscope. The diameters of the nickel nanowires at arbitrary 100 points in 10 visual fields were measured, and the average value was calculated.

### Average Length

The sample applied and dried on the sample stage in the same manner as (1) was photographed at a magnification of 2000 to 6000 using a scanning electron microscope. The lengths of 200 arbitrary nickel nanowires were measured, and the average value was calculated.

### Crystal Structure

The obtained nickel nanowires were applied onto a glass sample plate, and subjected to WAXD (wide angle X-ray diffraction measurement). From the resulting diffraction pattern was identified a crystal structure. The measurement conditions were CuKα ray = 1.54 Å, 50 kV, 300 mA, and 2θ/θ method.

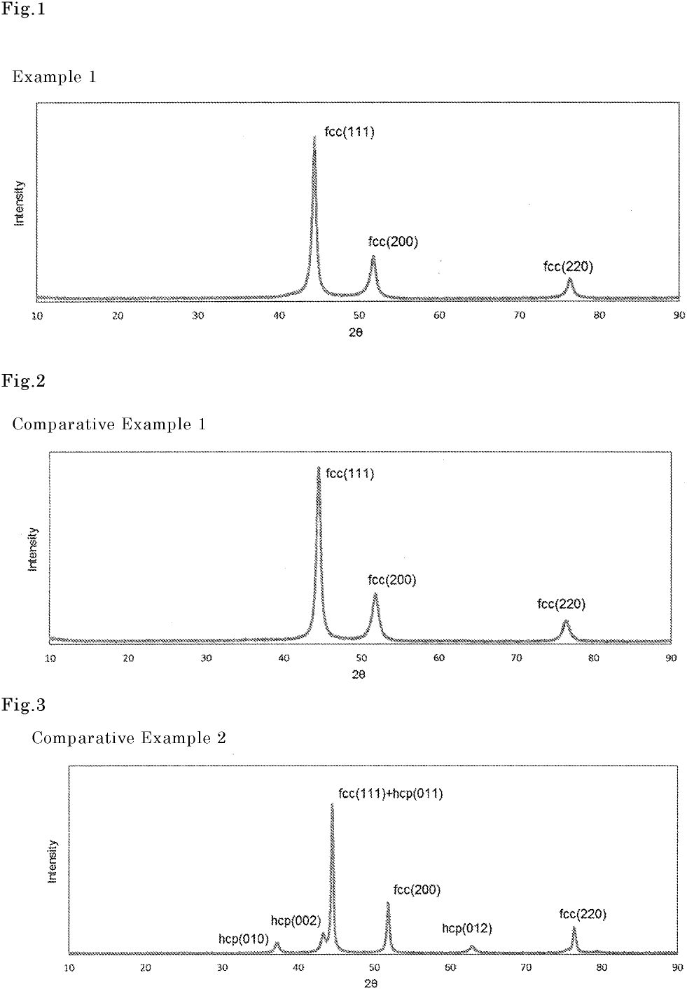

Specifically, a face-centered cubic lattice structure (fcc) was identified by the presence of a peak at 20 = 44.4°, a peak at 20 = 51.6 to 51.9°, and a peak at 20 = 76.3° in the diffraction pattern (for example, FIGS. 1 and 2). FIGS. 1 and 2 are the diffraction patterns of WAXD (wide-angle X-ray diffraction measurement) of the nickel nanowires produced in Example 1 and Comparative Example 1, respectively.

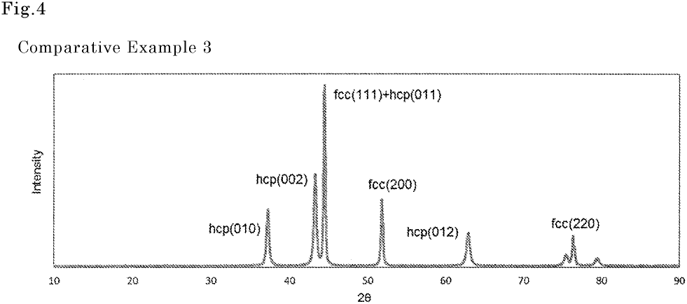

On the other hand, a hexagonal closest packing structure (hcp) was identified by the presence of a peak at 2θ = 37.2°, a peak at 2θ = 43.2°, and a peak at 2θ = 62.8° (for example, FIGS. 3 and 4). FIGS. 3 and 4 are the diffraction patterns of WAXD (wide-angle X-ray diffraction measurement) of the nickel nanowires produced in Comparative Examples 2 and 3, respectively. When there were peaks of both the crystal structures, it was assumed that both the crystal structures were formed.

From the diffraction pattern, the ratio of the hexagonal closest packing structure (hcp) to the face-centered cubic lattice structure (fcc) was calculated. Specifically, the ratio (hcp(010)/fcc(200)) of the integral value of the peak (010) at 2θ = 37.2° in the hexagonal closest packing structure to the integral value of the peak (200) at 20 = 51.6 to 51.9° in the face-centered cubic lattice structure was determined.

### Crystallite Size

From a diffraction pattern obtained by WAXD, multiple peaks were separated by JADE software, the corrected half widths β (rad) of the peaks corresponding to (111), (220), and (200) were determined from Formula (1), and the crystallite size in the direction in each lattice was determined from Scherrer’s formula (2). Specifically, a corrected half-value width β was determined by Formula (1) using a deconvolution constant of 1.3 and the value 0.1 as the device constant, and a crystallite size was determined by Formula (2) using the constant K of 0.9, λ of 1.5406 (the wavelength of the X-ray of CuKα1 used), the corrected half-value width as β, and the value of the diffraction angle as θ.

The measurement conditions by WAXD were as follows:

CuKα ray = 1.54 Å, 50 kV, 300 mA, 2θ/θ method.

### [Formula 1]

$${\text{β}}^{1.3} = {\left(\text{measure half-value width}\right)}^{1.3} - {0.1}^{1.3} \qquad \text{(1)}$$

$$\text{Crystallite size} \left(\text{nm}\right) = 0.1 \times \left(\text{K} \times \text{λ}\right) / \left(\text{β} \times \text{cos} \text{θ}\right) \qquad \text{(2)}$$

⊙: 40 nm or more (excellent);
○: 30 nm or more and less than 40 nm (good);
Δ: 15 nm or more and less than 30 nm (accepted);
×: Less than 15 nm (not accepted).

### Magnetic Properties

Obtained nanowires were filled in a sample holder, and a saturation magnetization (emu/g) was measured with a vibrating sample magnetometer (VSM).
⊙: 40 emu/g or more (excellent);
○: 30 emu/g or more and less than 40 mu/g (good);
Δ: 20 emu/g or more and less than 30 mu/g (accepted);
×: Less than 20 emu/g (not accepted).

### High-Temperature Resistance Properties

Obtained nickel nanowires (1 g) were processed into a non-woven fabric having a diameter of 70 mm, and subjected to heat treatment at 300° C. for 5 hours in an oven, and then the shape change of the nickel nanowire non-woven fabric was evaluated according to the following maintenance ratio and criteria.

The non-woven fabric was produced by the following method. Nanowires (1 g) were suspended in 1000 g of ethanol. Then, the nanowires were recovered from the resulting dispersion into a non-woven fabric shape using a filter holder KGS-90 and a filter Y100A090A (made by ADVANTEST CORPORATION), dried, and then peeled off from the filter, affording a non-woven fabric having a diameter of 70 mm composed of 1 g of nickel nanowires.

### [Formula 2]

$$\begin{matrix}\text{Maintenance ratio} \left(\%\right) \\ = \left(\text{planar area of non-woven fabric after heat treatment} / \text{planar area}\right) \\ \left(\text{non-woven fabric before heat treatment}\right) \times 100\end{matrix}$$

In the present invention, “o” or more is regarded as accepted, and “⊙” is preferable.
⊙: The maintenance ratio was 94% or more (excellent);
○: The maintenance ratio was 90% or more and less than 94% (accepted);
×: The maintenance ratio was less than 90% (not accepted);
× ×: Cracks occurred (not accepted).

### Example 1

Nickel sulfate hexahydrate (4.00 g (15.2 mmol)), nickel chloride hexahydrate (0.400 g (1.68 mmol)), and trisodium citrate dihydrate (0.375 g (1.27 mmol)) were added to ethylene glycol to make a total amount of 500 g. This solution was heated to 90° C. to allow dissolution.

In another container, 1.00 g (25.0 mmol) of sodium hydroxide was added to ethylene glycol to make a total amount of 499 g. This solution was heated to 90° C. to allow complete dissolution, and then hydrazine monohydrate (1.00 g (20.0 mmol)) was added.

The above two solutions were mixed, placed in a magnetic circuit capable of applying a magnetic field of 150 mT at the center, and subjected to a reduction reaction for 15 minutes while being maintained at 90 to 95° C.

After the reaction, 28% ammonia water (25 g (the ammonia amount: 7 g (= 411.8 mmol))) was added, and nickel nanowires were collected by filtration.

### Examples 2 to 3 and Comparative Examples 1 to 4

Nickel nanowires were collected by performing the same operations as in Example 1 except that the type and the used amount of the nickel salts were changed to the amounts given in Table 1.

### Example 4

Nickel sulfate hexahydrate (4.00 g (15.2 mmol)), nickel chloride hexahydrate (0.400 g (1.68 mmol)), and trisodium citrate dihydrate (0.375 g (1.27 mmol)) were added to ethylene glycol to make a total amount of 500 g. This solution was heated to 90° C. to allow dissolution.

In another container, 1.00 g (25.0 mmol) of sodium hydroxide was added to ethylene glycol to make a total amount of 499 g. This solution was heated to 90° C. to allow complete dissolution, and then 28% ammonia water (25 g (the amount of ammonia: 7 g (= 411.8 mmol))) and hydrazine monohydrate (1.00 g (20.0 mmol)) were sequentially added.

The above two solutions were mixed, placed in a magnetic circuit capable of applying a magnetic field of 150 mT at the center, and subjected to a reduction reaction for 15 minutes while being maintained at 90 to 95° C.

After the reaction, nickel nanowires were collected by filtration.

### Comparative Example 5

An attempt of obtaining nickel nanowires was made by performing the same operations as in Example 1 except that the used amounts of nickel chloride hexahydrate and nickel sulfate hexahydrate were changed to the amounts given in Table 1. However, since the concentrations of nickel chloride hexahydrate and nickel sulfate hexahydrate were equimolar concentrations, nanowires failed to be obtained.

TABLE 1

| | | | | | Example 1 | Example 2 | Example 3 | Example 4 | Comparative Example 1 | Comparative Example 2 | Comparative Example 3 | Comparative Example 4 | Comparative Example 5 |
|---|---|---|---|---|---|---|---|---|---|---|---|---|---|
| Production conditions | Nickel salt | Nickel salt (1) | Type | | Nickel sulfate | Nickel sulfate | Nickel sulfate | Nickel sulfate | Nickel chloride | Nickel sulfate | Nickel sulfate | Nickel chloride | Nickel chloride |
| | | | Concentration mmol/g | | 0.0152 | 0.0152 | 0.0160 | 0.0152 | 0.0168 | 0.0168 | 0.0168 | 0.0121 | 0.0084 |
| | | Nickel salt (2) | Type | | Nickel chloride | Nickel chloride | Nickel chloride | Nickel chloride | - | - | - | Nickel sulfate | Nickel sulfate |
| | | | Concentration | mmol/g | 0.0016 | 0.0016 | 0.0008 | 0.0016 | - | - | - | 0.0047 | 0.0084 |
| | | Ratio of nickel salt (1) | | mol% | 90 | 90 | 95 | 90 | - | - | - | 72 | 50 |
| | Complexing agent | Trisodium citrate | | mmol/g | 0.00127 | - | - | 0.00127 | - | 0.00127 | - | - | 0.00127 |
| | | Ratio to all nickel salts | | mol% | 7.6 | - | - | 7.6 | - | 7.6 | 7.6 | 7.6 | 7.6 |
| Evaluation | (1) Average diameter | | | nm | 189 | 124 | 211 | 192 | 118 | 57 | 57 | 133 | Particulate |
| | (2) Average length (Aspect ratio) | | | µm | 28 (148) | 27 (218) | 20 (95) | 26 (135) | 21 (178) | 7 (123) | 4 (70) | 16 (120) | Particulate (1 to 2) |
| | (3) Crystal structure (hcp/fcc) | | | | fcc (<0.1) | fcc (<0.1) | fcc (<0.1) | fcc (<0.1) | fcc (<0.1) | fcc+hcp (0.17) | fcc+hcp (0.73) | fcc (<0.1) | - |
| | (4) Crystallite size | | 111 | nm | 19.2Δ | 49.6⊙ | 46.9⊙ | 19.5Δ | 14.9× | 39.30 | 63.1⊙ | 8.1× | - |
| | | | 100 | nm | 11.4 | 36.5 | 41.9 | 11.3 | 9.0 | 32.2 | 54.3 | 4.8 | - |
| | | | 110 | nm | 13.6 | 44.5 | 47.1 | 13.7 | 10.3 | 40.9 | 66.3 | 5.2 | - |
| | (5) Magnetic properties | | Saturation magnetization | emu/g | 47⊙ | 48⊙ | 46⊙ | 45⊙ | 43⊙ | 19× | 16× | 360 | - |
| | (6) High-temperature resistance properties | | State after treatment | State | 91% maintained | 94% maintained | 94% maintained | 92% maintained | Crack | 92% maintained | 93% maintained | Crack | - |
| | | | | Evaluation | O | ⊙ | ⊙ | O | × × | O | O | × × | - |

fcc: face-centered cubic lattice structure, hcp: hexagonal closest packing structure, “-”: not measured or not evaluated.

In the nickel nanowires of Examples 1 to 4, the crystal structure was fcc and the crystallite size in the direction of a (111) lattice plane was 15 nm or more. For this reason, the shape was maintained even when the nanowires were treated at a high temperature.

In particular, in the nickel nanowires of Examples 2 and 3, the crystallite size in the direction of the (111) lattice plane was 30 nm or more, particularly 40 nm or more, and thus the rate of change in shape was small.

Since the nickel nanowires of Comparative Examples 1 and 4 were produced using one or more kinds of nickel salts not including nickel sulfate, the crystallite size in the direction of the (111) lattice plane was less than 15 nm, and cracks were formed by a high-temperature treatment, and non-woven fabrics were broken.

In Comparative Examples 2 and 3, since the nickel nanowires were produced using a nickel salt of only nickel sulfate, an hcp structure was mixed, so that the magnetic properties (saturation magnetization) were low and the average length of the nanowires was short.

### INDUSTRIAL APPLICABILITY

The nickel nanowires of the present invention are electrical conductors or high dielectric constant materials, and are suitable for an electric wiring, an electrode material, an electrical wave shielding material, an antenna substrate, an electrical wave absorbing material, and the like.

1. A nickel nanowire having a face-centered cubic lattice structure, a crystallite size in a direction of a (111) lattice plane of 15 nm or more and a saturation magnetization of 20 emu/g or more.

2. The nickel nanowire of claim 1, having an average diameter of 50 nm or more and less than 1 µm.

3. The nickel nanowire of claim 1, wherein a content ratio (hcp/fcc) of a hexagonal closest packing structure to the face-centered cubic lattice structure in the nickel nanowire is 0.2 or less.

4. The nickel nanowire of claim 1, wherein the nickel nanowire is composed of nickel having only the face-centered cubic lattice structure.

5. The nickel nanowire of claim 1, wherein the nickel nanowire has an average length of 10 µm or more.

6. The nickel nanowire of claim 1, wherein a crystallite size in a direction of a (110) lattice plane is 10 nm or more, and
a crystallite size in a direction of a (100) lattice plane is 10 nm or more.

7. The nickel nanowire of claim 1, wherein the crystallite size in the direction of the (111) lattice plane is 30 nm or more.

8. A dispersion comprising the nickel nanowire of claim 1.

9. A molded article comprising the nickel nanowire of claim 1.

10. A method for producing a nickel nanowire, the method comprising reducing two or more kinds of nickel salts including nickel sulfate in a reaction solution while applying a magnetic field to obtain the nickel nanowire of claim 1.

11. The method for producing the nickel nanowire of claim 10, wherein the two or more kinds of nickel salts include nickel sulfate and nickel chloride, and
a ratio of the nickel sulfate to a total of the nickel sulfate and the nickel chloride is 70 to 98 mol%.
